(19) United States
(12) Patent Application Publication
(10) Pub. No.: US 2026/0127446 A1
(43) Pub. Date: May 7, 2026

(54) ACCELERATION METHOD AND SYSTEM FOR HETEROGENEOUS GRAPH NEURAL NETWORKS BASED ON META-PATH GRAPHS

(71) Applicant: Huazhong University of Science and Technology, Wuhan (CN)

(72) Inventors: Long ZHENG, Wuhan City (CN); Haiheng HE, Wuhan City (CN); Xiaofei LIAO, Wuhan City (CN); Hai JIN, Wuhan City (CN); Haifeng LIU, Wuhan City (CN); Yu HUANG, Wuhan City (CN)

(73) Assignee: Huazhong University of Science and Technology, Wuhan (CN)

(21) Appl. No.: 19/093,987

(22) Filed: Mar. 28, 2025

(30) Foreign Application Priority Data
Nov. 5, 2024 (CN) 202411569136.4

(51) Int. Cl. G06N 3/0985; G06N 3/042

(52) U.S. Cl. CPC G06N 3/0985; G06N 3/042

(57) ABSTRACT

An acceleration method for heterogeneous graph neural networks based on meta-path graphs is provided, including: constructing a meta-path graph by arranging all meta-path instances in graph form, based on a given heterogeneous graph and specified types of meta-paths; partitioning the meta-path graph to obtain multiple meta-path subgraphs, which are further divided by workload; performing layer-based encoding on the meta-path instances according to the workload distribution; merging all meta-path instance slice encodings based on inter-layer relationships in the meta-path graph to obtain meta-path instance encodings; and performing intra-meta-path aggregation and inter-meta-path aggregation to compute the final features of the target vertices. The present method significantly reduces redundant computations in heterogeneous graph neural network, thereby improving model inference efficiency.

This application claims the benefit of Chinese Patent Application No. CN 202411569136.4, filed on Nov. 5, 2024, which is hereby incorporated by reference as if fully set forth herein.

### BACKGROUND OF THE APPLICATION

### 1. Technical Field

The present disclosure relates to acceleration of heterogeneous graph neural networks (HGNNs), and more particularly to an acceleration method and system for heterogeneous graph neural networks based on meta-path graphs.

### 2. Description of Related Art

Heterogeneous graphs represent a graph structure in which vertices and edges have different types. In a heterogeneous graph, connections between vertices and/or with edges can be diverse and complex, reflecting various types of relationships in the real world. Key concepts in heterogeneous graphs include: 1. Vertex Type. In a heterogeneous graph, vertices can be classified into different types, each with specific attributes and semantics. For example, in a social network, vertex types may include users, groups, and pages. 2. Edge Type. Similarly, edges in a heterogeneous graph can represent various types of relationships between vertices. For example, in a social network, edge types may represent “friend” relationships, “like” relationships, or “comment” relationships. 3. Meta-Path. A meta-path defines a specific type of connection between vertices. It describes how a path, composed of a sequence of vertices and edge types, connects one vertex to another. Meta-paths are crucial tools for capturing the complex relationships between vertices in a heterogeneous graph.

A heterogeneous graph neural network (HGNN) is a neural network model designed for processing heterogeneous graph data. As compared to common graph neural networks (GNNs), HGNNs can effectively handle different types of vertices and edges in heterogeneous graphs. The development of HGNNs can be traced back to common graph representation learning methods, such as vertex embedding and graph embedding. With the advancement of deep learning, GNNs were introduced to learn representations of graph data. Due to the complexity of heterogeneous graphs, researchers have proposed various GNN-based heterogeneous graph models to address challenges posed by heterogeneous graph data. These models aim to learn representations for the different types of vertices in a heterogeneous graph, enabling the transmission and learning of information through the connections between vertices.

Multivariate mapping relationships between meta-paths and heterogeneous graphs often lead to a huge number of meta-path instances, and maintenance of such massive meta-path instances presents a significant challenge. Early research used breadth-first search (BFS) to match meta-path instances. A BFS-based HGNN approach first enumerates all meta-path instances, and stores them in large memory spaces that may be thousands of times larger than the original graph. These instances can then be directly accessed by the encoder. However, because each meta-path instance is stored separately, the encoding process becomes unavoidably affected by redundant computations. Furthermore, encoding meta-path instances by vertex index order can lead to load imbalances. A recent solution employs depth-first search (DFS) for traversing (to generate) meta-path instances from the original graph. The DFS-based approach matches meta-path instances during construction of a semantic graph. Once a meta-path instance is matched, its semantic information will be encoded into the embedding and used to incrementally update the semantic graph before finally being discarded. Therefore, a DFS-based HGNN can save storage overheads significantly because the meta-path instances no longer need to be stored. However, discarding the meta-path instances after use introduces additional overheads, as the system must re-match meta-path instances from the original graph during model inference, which increases inference latency. Although the DFS-based approach may be effective in minimizing redundant computation for meta-path instances of the same target vertex by changing the encoding sequence and direction of meta-path instances, redundant computation across different target vertices remains. Both approaches fail to resolve some critical issues in HGNNs, such as high costs for constructing semantic graphs, memory overheads, and redundant computation. Hence, the present disclosure aims to design an efficient HGNN system.

CN114298279A discloses a method for constructing design space of heterogeneous graph neural network (HGNN) with multiple design dimensions. It provides a unified HGNN framework and defines the design space for HGNNs based on this framework. This approach overcomes the limitations of previous works, which evaluated HGNNs only at the model level. It introduces a module-level evaluation perspective, enabling researchers to analyze design dimensions that significantly impact model performance. A platform, Space4HGNN, is established therein for constructing the HGNN design space. Based on this platform, principles and guidelines for model design are provided, offering standard evaluation and modular implementation for HGNNs. While the platform provides module-level evaluation for researchers, offers a simple interface for users, and helps evaluate the impact of different design dimensions, it does not fully address all the existing issues in HGNNs.

As previously discussed, meta-path-based HGNNs have been widely used, but none of the disclosures in the existing art addresses the specific issues solved by the present disclosure. The present disclosure aims to provide an efficient method and system for generating meta-paths in HGNNs.

Additionally, due to potential discrepancies in understanding between those skilled in the art and patent examiners, and because the applicant has referred to a large body of literatures and patents during the development of this application, it should be noted that the present disclosure incorporates the technical features of all relevant existing works. The applicant reserves the right to supplement this application with further details and features from related existing art, as appropriate, in accordance with relevant regulations.

### SUMMARY OF THE APPLICATION

Currently, most HGNNs employs depth-first search (DFS) for traversing (to generate) meta-path instances from the original graph. The DFS-based approach supports the matching of meta-path instances during the construction of the semantic graph. Once a meta-path instance is matched, its semantic information is immediately encoded into the embedding, which is then used to incrementally update the semantic graph before finally being discarded. Therefore, DFS-based HGNNs do not need to store meta-path instances, significantly reducing storage overhead. However, discarding the meta-path instances after use may lead to additional overhead during model inference, as it requires rematching the meta-path instances from the original graph, thus increasing inference latency. While the DFS-based approach may be effective in minimizing redundant computations for meta-path instances of the same target vertex by changing the encoding sequence and matching direction, redundant computations across different vertices still persist. Neither BFS- nor DFS-based methods fully resolve the issues inherent in HGNNs, such as high semantic graph construction costs, memory overheads, and redundant computations.

In view of the shortcomings of the existing art, the present disclosure provides, in one aspect, an acceleration method for heterogeneous graph neural networks (HGNNs) based on meta-path graphs. The method comprises: constructing a meta-path graph by arranging all meta-path instances in graph form, based on a given heterogeneous graph and specified types of meta-paths; partitioning the meta-path graph to obtain multiple meta-path subgraphs; dividing the meta-path subgraphs by workload; performing layer-based encoding of the meta-path instances according to the workload distribution, and merging all meta-path instance slice encodings based on inter-layer relationships in the meta-path graph to obtain meta-path instance encodings; and performing intra-meta-path aggregation and inter-meta-path aggregation to compute final features of target vertices.

By constructing meta-path graphs, the present disclosure effectively integrates information within a heterogeneous graph, thereby accelerating the computation of graph neural networks. The meta-path graph not only provides deep representations of certain types of relationships, but also optimizes computation through efficient data structures. This significantly reduces the computational complexity of HGNN models, enabling faster training and improved inference efficiency when processing large-scale heterogeneous graphs.

According to a preferred embodiment, the step of constructing the meta-path graph comprises: extracting vertices and edges from the heterogeneous graph according to the types appearing in the meta-paths; and copying repeated vertices and edges into the previously constructed portion of the meta-path graph, and further expanding them according to the meta-path schema to form a complete meta-path graph. The resulting meta-path graph not only possesses strong representational power but also ensures structural integrity and consistency of the graph by replicating and expanding repeated vertices and edges, thereby improving the neural network's ability to learn complex relationships.

According to a preferred embodiment, the step of partitioning the meta-path graph comprises: collecting the vertices in central layers of the meta-path graph to obtain all the central-layer vertices; dividing the central-layer vertices into multiple batches, with each batch containing an equal number of central-layer vertices; and traversing the meta-path graph from all the vertices in each batch, respectively, in both outgoing and incoming edge directions, so as to obtain the meta-path subgraphs corresponding to each batch.

When partitioning the meta-path graph, collecting the central-layer vertices and processing them in batch effectively reduces the computational load. This simplifies the graph structure of every batch, thereby facilitating subsequent computations. The batch-based strategy allows parallel processing of multiple subgraphs, and improves the overall computational efficiency. Especially in scenarios involving large-scale graph data, this strategy significantly accelerates the training and inference speed of HGNN models.

According to a preferred embodiment, the step of dividing the meta-path subgraphs by workload comprises: dividing the meta-path subgraph into at least two sections by layer, with each section containing contiguous layers, thus forming a meta-path slice graph that contains part of the meta-path instances; and traversing the meta-path slice graphs in layer sequence, so as to obtain slices for all the meta-path instances.

Dividing each meta-path subgraph into multiple sections by layer and forming meta-path slice graphs enables independent processing of information at different layers. This not only facilitates more efficient computation, but also allows for the extraction of finer features from meta-path instances through layer-based traversal of the slice graphs. In this way, the HGNN model can capture the layered structure more accurately during the learning process, thereby improving its representation capability.

According to a preferred embodiment, the meta-path instance encodings are obtained through: encoding the meta-path instance slices to obtain partial encodings for the meta-path instances; using edge relationships across different layers to re-encode the meta-path instance slice encodings in different subgraphs, so as to obtain the complete set of meta-path instance encodings; performing intra-meta-path aggregation within the same meta-path subgraph to obtain feature information for the target vertices; and performing inter-meta-path aggregation for the feature information of the target vertices across different meta-path graphs to compute the final features of all the target vertices.

During the process of acquiring the meta-path instance encodings, merging the embeddings of different subgraphs based on inter-layer relationships allows the graph's structural information to be fully utilized, enriching the feature representation. By performing aggregation calculations both within individual meta-path instances and between different meta-path instances, feature information for the target vertices is obtained, demonstrating the significant technical effect of the disclosed method in improving the quality of feature fusion and the efficiency of information transfer. This contributes to better performance in downstream tasks.

According to a preferred embodiment, the step of encoding the meta-path instance slices comprises: determining whether there are identical sequential parts in the meta-path definitions corresponding to the meta-path graphs; and if yes, implementing priority-based layer division; otherwise, implementing layer-based division.

The present disclosure effectively improves the encoding process in terms of both efficiency and accuracy by determining whether identical sequential parts exist in the meta-path graphs and implementing priority-based layer division. As compared to existing methods, the layer-based division strategy in the present disclosure allows rapid identification of similar structures, reducing redundant computations and significantly accelerating the encoding process. With the assistance of this technical effect, when dealing with complex heterogeneous-graph structures, HGNN models can adapt more flexibly and efficiently to different computational needs, thereby enhancing the overall versatility of the HGNN model.

The present disclosure, in another aspect, provides an acceleration system for heterogeneous graph neural networks (HGNNs) based on meta-path graphs. The system comprises a construction module, a partitioning module, a computation module, and a merging module. The construction module constructs meta-path graphs by arranging all meta-path instances in graph form, based on a given heterogeneous graph and specified types of meta-paths. The partitioning module partitions the meta-path graph to obtain multiple meta-path subgraphs. The computation module divides the meta-path subgraphs by workload. The merging performs layer-based encoding on the meta-path instances according to the workload distribution, merges all meta-path instance slice encodings based on inter-layer relationships in the meta-path graph to obtain the meta-path instance encodings, and performs intra-meta-path aggregation and inter-meta-path aggregation to compute final features of target vertices.

The system, with its modular design, allows each modules to run in parallel on dedicated hardware units (such as GPUs or multi-core CPUs), thereby improving the speed and efficiency of information processing. At the hardware level, the disclosed system can quickly process massive heterogeneous graph data through parallel computing and efficient data transmission, reducing computational latency and optimizing resource utilization, thereby ensuring high efficiency in real-time applications.

According to a preferred embodiment, the construction module comprises multiple construction sub-modules, which are responsible for constructing the meta-path graphs. These construction sub-modules each comprise an extraction module and an expansion module. The extraction module extracts vertices and edges from the heterogeneous graph according to the types specified in the meta-paths. And the expansion module copies repeated vertices and edges into the previously constructed portion of the meta-path graph, and further expands according to the meta-path schema, thereby forming a complete meta-path graph.

The extraction and the expansion modules in the construction module leverage efficient data structures and memory management to rapidly extract vertices and edges from the heterogeneous graph and construct the meta-path graph. This process optimizes hardware access using the parallel reading and writing to optimize memory access, thereby significantly accelerating information processing. Such a capability of efficient construction allows the disclosed system to generate necessary graph data rapidly when dealing with complex graph structures, thereby reducing construction time.

The partitioning module is designed to allow hardware to partition the graphs using parallel algorithms, enabling rapid generation of multiple meta-path subgraphs. This design advantageously reduces the demand for computational resources, as the hardware can efficiently utilize multiple cores or processing units to work simultaneously, so as to reduce the overall computational load and improve information processing performance. This ensures efficient subsequent computations, and facilitates processing of large-scale graph data.

According to a preferred embodiment, the computation module comprises multiple computation sub-modules. Each computation sub-module divides the meta-path subgraphs by workload, according to layers, to obtain multiple meta-path slice graphs and perform encoding computations. The computation sub-modules each include a loading module and an encoding module. The loading module divides the meta-path subgraph into at least two sections by layers, with each section containing contiguous layers, thus forming a meta-path slice graph that contains part of the meta-path instances. The encoding module traverses the meta-path slice graphs in layer order to obtain slices for all the meta-path instances.

The computation module maximizes the use of hardware parallel computing capabilities by intelligently by distributing workloads across the meta-path subgraphs. The design of the loading module and the encoding module ensures that the hardware can process multiple tasks during the encoding process, significantly accelerating computation. Meanwhile, the layer-based traversal strategy further improves the efficiency of data processing, reduces memory bandwidth occupancy, and effectively enhances information processing efficiency.

According to a preferred embodiment, the merging module comprises multiple merging sub-modules. These merging sub-modules each comprise an encoding-merging module, an intra-meta-path aggregation module, and an inter-meta-path aggregation module. The encoding-merging module encodes the meta-path instance slices to obtain partial encodings for the meta-path instances, and uses edge relationships across different layers to re-encode the meta-path instance slice encodings in different subgraphs, so as to obtain the complete set of meta-path instance encodings. The intra-meta-path aggregation module performs intra-meta-path aggregation within the same meta-path subgraph, so as to obtain feature information of the target vertices. The inter-meta-path aggregation module performs inter-meta-path aggregation for the feature information of the target vertices across different meta-path graphs, so as to compute the final features of all the target vertices.

The merging module achieves rapid integration of computation results through encode merging and aggregation both within and between meta-paths. At the hardware level, this module effectively manages data flows and reduces the need for data transmission between processing units, thereby accelerating data transfer. Additionally, the efficiency of aggregation computations enables the disclosed system to quickly obtain final features of target vertices, and thereby improves the overall performance and accuracy in information processing.

### BRIEF DESCRIPTION OF THE DRAWINGS

FIG. 1 is a flowchart of an acceleration method for HGNNs based on meta-path graphs according to one embodiment of the present disclosure;

FIG. 2 is a schematic diagram exemplifying parallel implementation of the acceleration method according to one embodiment of the present disclosure;

FIG. 3 is a schematic diagram exemplifying construction of meta-path graphs as part of the acceleration method according to one embodiment of the present disclosure;

FIG. 4 is a schematic diagram exemplifying layer-based encoding operation as part of the acceleration method according to one embodiment of the present disclosure;

FIG. 5 shows all meta-path instances of a meta-path APCPA in a heterogeneous graph and the corresponding meta-path graph; and

FIG. 6 is a structural diagram showing connection of modules in an acceleration system for HGNNs based on meta-path graphs according to one embodiment of the present disclosure.

### DETAILED DESCRIPTION OF THE APPLICATION

The present disclosure will be described in detail with reference to the accompanying drawings.

Some terms used in this disclosure shall have the following definitions:

A heterogeneous graph is a graph data structure that contains multiple types of vertices or multiple types of edges. This is in contrast to a homogeneous graph, which only contains one type of vertices and one type of edges. It is typically represented as G=(V, E, Vₜ, Eₜ), where V is the set of all vertices in the graph, E is the set of all edges in the graph, Vₜ is the set of vertex types in the graph, and Eₜ is the set of edge types in the graph.

A meta-path is a sequence that represents a combination of vertex types, and is typically written as V₁V₂. . . Vₙ, where V₁, V₂, . . . , Vₙ∈Vₜ. A meta-path describes a combination of relationships between multiple vertices.

A meta-path instance is a path in the graph where the vertex types in the path satisfy the definition of the meta-path (i.e., the instantiated meta-path). It is typically represented as v₁v₂. . . vₙ, where v₁, v₂, . . . , vₙ∈V.

A meta-path graph, as used herein, refers to a compressed storage format for meta-path instances. Such a graph stores all meta-path instances.

For an HGNN, meta-path instances are typically obtained by performing a DFS-based traversal on the original graph. The existing DFS-based method is effective in matching meta-path instances while constructing the semantic graph. Once a match is found, the semantic information is immediately encoded into the embedding vector instantly and used for incremental updates of the semantic graph. Eventually, these meta-path instances are no longer needed. This known DFS-based method significantly reduces memory costs by not storing meta-path instances. However, once the meta-path instances are discarded, the HGNN model may need to rematch the meta-path instances from the original graph during each inference. This brings about additional computational latency. Although the DFS-based strategy can prevent unnecessary computations for meta-path instances of the same target vertex by adjusting the encoding sequence and matching direction, redundant computations still occur among different vertices. To sum up, neither BFS nor DFS methods completely resolve the key issues faced by HGNNs, such as the high cost of constructing semantic graphs, memory usage, and redundant computations.

For example, on an on-line social media platform, users, posts, and comments are essentials of interaction. User A posts about a healthy diet and receives many comments. User B and C show interest in this post, with User B praising the recipe and User C asking for more recommendations. Later, User D joins the discussion, expressing interest in the diet plan and asking for more information.

In this context, the platform's recommendation system uses DFS to analyze content relevant to users, and provides personalized recommendations for new user E. However, since the system does not store previous comments or interactions, each time User E logs in, the system has to reprocess all comments related to the post of User A again. This not only wastes computational resources, but also significantly increases User E's waiting time, negatively affecting the user experience.

If the recommendation system could effectively store this interaction data, it could quickly respond to the request of user E by directly retrieving the comments of User B, C, and D, thereby reducing redundant computations and improving recommendation efficiency.

To address the shortcomings of the existing art, the present disclosure provides an acceleration method and system for HGNNs based on meta-path graphs. The method and system of the present disclosure can be used in social network analysis. For example, the disclosed method can be used to efficiently analyze heterogeneous graph data in social networks, identify relationships and influence among users, and support applications such as recommendation systems and community detection. The method and system of the present disclosure can also be used for knowledge graph construction. For example, the acceleration method accelerates construction of and inference of knowledge graphs, enabling rapid extraction of relationships and insights from massive heterogeneous data, thereby supporting intelligent Q&A and information retrieval. The method and system of the present disclosure can also be used in bioinformatic research. In bioinformatics, the disclosed acceleration method based on meta-path graphs can be used to analyze complex biological networks, helping to identify gene-gene interactions and disease-related biomarkers. The method and system of the present disclosure can further be used to optimize logistics and supply chains by analyzing heterogeneous logistics networks and refining path planning and resource allocation in supply-chain management, thereby improving operational efficiency and lowering costs. The method and system of the present disclosure can also be used in financial risk assessment. For example, the HGNN acceleration method can be used to analyze the complex relationship among clients, transactions, and markets in financial data, thereby enhancing financial risk assessment and improving fraud detection accuracy.

The present disclosure may further provide an efficient graph data processing accelerator, which efficiently processes heterogeneous graph data, encodes of the meta-path graphs, and inference computations, thereby improving the overall computation speed.

The present disclosure may further provide an HGNN analysis device, which can be used for various HGNN analyses to support construction and processing of meta-path graphs. This device is suitable for both academic and industrial applications.

The present disclosure may further provide an optimization algorithm for partitioning and encoding meta-path graphs. This algorithm optimizes the partitioning and encoding processes for meta-path graphs, thereby improving the efficiency of HGNN inference and overcoming performance bottlenecks.

The present disclosure may further provide an HGNN inference platform, which integrates the disclosed method into a software platform and provides a user-friendly interface and API to facilitate HGNN inference and analysis in various applications.

The present disclosure further provides an intelligent HGNN processing system and method as a comprehensive solution that supports data storage, graph partitioning, workload management, and inference computation for heterogeneous graphs, which is suitable for processing large-scale graph data.

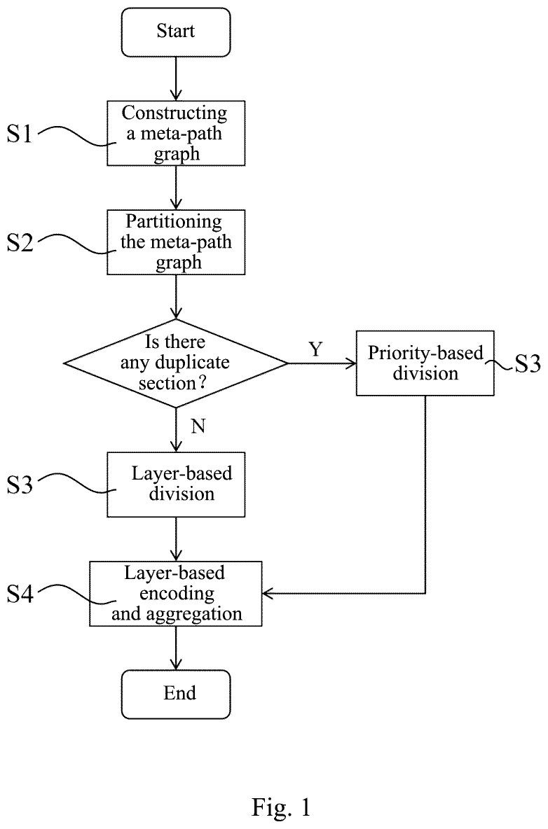

The present disclosure provides an acceleration method for HGNNs based on meta-path graphs, as shown in FIG. 1. After the initial step, the method may further comprise the following steps.

Step S1 involves constructing a meta-path graph.

According to a given heterogeneous graph and a specified meta-path containing certain types, all meta-path instances are stored in graph form, referred to as a meta-path graph herein.

Step S2 involves partitioning the meta-path graph.

The meta-path graph is partitioned into multiple meta-path subgraphs.

At Step S3, if any duplicate sections are detected, a priority-based layer division is performed. If no duplicate sections are found, layer-based division is applied to distribute the workload across the meta-path subgraphs.

Step S4 involves layer-based encoding and aggregation.

According to the workload distribution, the meta-path instances are encoded by layer to generate the encodings for all meta-path instances, which are then used in subsequent inference computations related to the HGNN.

The method then concludes.

Specifically, Step S1 comprises the following sub-steps.

At S11, for a given meta-path, vertices and edges are extracted from the heterogeneous graph based on the types appearing in the meta-path. These vertices and edges form part of the meta-path graph.

Step S111 involves determining the structure of the meta-path. The meta-path structurally comprises a starting vertex, a target vertex, and the types and sequence of edges between them. For example, a meta-path may be represented as “User-Purchase-Article”, where “User” and “Article” are vertices, and “Purchase” is the edge type.

Step S112 involves identifying the types appearing in the meta-path.

This is achieved by analyzing the type of each vertex and edge in the meta-path, and recording the definition of every type in the heterogeneous graph. Different types of vertices and edges may affect the structure and properties of the graph.

Step S113 involves extracting vertices and edges from the heterogeneous graph.

This step uses a database query or graph traversal algorithm (such as DFS or BFS) to extract vertices and edges that correspond to the types in the meta-path from the heterogeneous graph. It is important to ensure that the vertices connected by the extracted edges meet the sequence and type requirements of the meta-path.

Step S114 involves constructing the initial portion of the meta-path graph.

The extracted vertices and edges are combined to form the initial portion of the meta-path graph. At this stage, the graph may contain scattered vertices and edges but is not yet a complete structure.

Step S12 involves copying any repeated vertices and edges into the initial meta-path graph, and expanding the graph according to the meta-path schema to form a complete meta-path graph.

At S121, it is determined whether any duplicates exist.

This is achieved by traversing the extracted vertices and edges and checking which of them already exist in the constructed meta-path graph.

A Hash table or set can be used to efficiently store and check for existing vertices and edges.

Step S122 is about duplication.

For each repeated vertex or edge, it is copied and added to the constructed meta-path graph to ensure the edge connections remain unchanged. The position of each element in the meta-path graph is recorded to facilitate subsequent processing.

At Step S123, expansion is made according to the meta-path schema.

The graph is further expanded by adding new vertices and edges according to the structure and patterns of the meta-path (e.g., the specific order in which vertices are connected by edges). It is important to ensure that the added elements are consistent with the existing elements in the graph and follow the definition of the meta-path.

At Step S124, a complete meta-path graph is formed.

After all vertices and edges are added, the connectivity of the meta-path graph is checked to ensure there are no isolated vertices or edges, so that the graph can completely represent the logical structure of the meta-path.

Step S13 involves repeating Steps S11 and S12 for different meta-paths, so as to obtain meta-path graphs corresponding to all meta-paths.

A meta-path graph is a layered multipartite graph. In a meta-path graph, vertices can be divided into multiple layers, with the number of layers equal to the length of the meta-path plus 1, where each layer corresponds to a vertex type in the meta-path.

Vertices in each layer can only be connected to vertices in adjacent layers through edges. This creates an ordered, layered structure that facilitates inference and computation.

The adjacency matrix of such a meta-path graph is a sparse block matrix. Only the block between the vertex in one layer and the vertex in the next layer contains non-zero elements, and all other blocks are zero. In other words, non-zero elements in the adjacency matrix of a meta-path graph appear only in the blocks corresponding to a vertex layer and its adjacent next layer, with all other blocks being zero. This configuration not only saves storage space, but also enhances computational efficiency, as the operations focus primarily on connections between adjacent layers.

At Step S131, different meta-paths are prepared.

This step involves determining a set of meta-paths to be processed. The meta-paths may have different types of vertices and edges, and therefore have to be processed separately.

Step S132 is to iteratively process the meta-paths.

Steps S11 and S12 are repeated for every meta-path.

At Step S11, vertices and edges corresponding to the current meta-path are extracted to form the initial part of the meta-path graph. Then with Step S12, duplicate vertices and edges are identified and copied, so that expansion can be made according to the meta-path schema to form a complete meta-path graph.

At Step S133, all the meta-path graphs are collected.

After all the meta-paths are processed, the generated meta-path graphs are collected to ensure they are available for subsequent steps.

Step S2 comprises the following sub-steps.

Step S21 involves collecting the vertices in central layers of a specific meta-path graph, so as to obtain all central-layer vertices of the meta-path graph.

First, the definition of the “central layer” in a meta-path graph has to be clarified. Generally, a central layer refers to key vertices in the meta-path that connect upper and lower layers. These vertices are typically the intermediate vertices in the meta-path.

The meta-path graph is then traversed to identify and extract all vertices in the central layers. This can be done using a graph traversal algorithm (such as BFS or DFS). During traversal, every vertex is assigned a layer-level marker to distinguish vertices across different layers.

The identified central-layer vertices are all stored in a list or set to ensure their uniqueness and integrity. By effectively collecting and marking the central-layer vertices, a solid data foundation is provided for subsequent processing to ensure that the structure and relationships of the graph can be fully used. The selection of central-layer vertices directly impacts the efficiency and effectiveness of subsequent computations.

Step S22 involves grouping the central-layer vertices into multiple batches, with each batch containing an equal number of central-layer vertices.

Specifically, according to the actual needs and available computing resources, the number of central-layer vertices in each batch is determined. This number should be balanced to avoid excessive computational load during traversal. According to the specified batch size, the collected central-layer vertices are then grouped. If the total number of vertices is not divisible by the batch size, the last batch can contain the remaining vertices. An algorithm (such as a chunking algorithm) can be used to ensure that the vertices are evenly distributed, thus minimizing load imbalances for the batches.

Dividing the central-layer vertices into batches improves parallel processing efficiency, enabling multiple batches to be processed simultaneously during the subsequent traversal, which enhances overall computational performance.

Step S23 involves starting from all vertices in each batch and traversing the meta-path graph along both outgoing and incoming edge directions, respectively, so as to obtain the meta-path subgraphs corresponding to each batch.

Specifically, the traversal direction (outgoing or incoming edges) is determined, and a corresponding traversal strategy is designed for each batch according to the vertices in that batch. The outgoing-edge traversal starts from a vertex, involves accessing the adjacent vertices in the next layer, while the incoming-edge traversal works in the reverse direction. For each batch, outgoing-edge and incoming-edge traversals are performed to form a vertex. For example, this process may be performed using DFS or BFS. During traversal, the accessed vertices and edges are recorded, forming a meta-path subgraph for the corresponding batch. According to the traversal results, a meta-path subgraph is constructed for each batch. Every subgraph contains the vertices from the batch and the edges connecting them, so as to form a relatively independent structure.

Through effective traversal strategies and subgraph construction, the complex meta-path graph is decomposed into manageable parts, which helps reduce computational complexity and provides a clear graph structure for subsequent analysis.

Step S24 involves repeating Steps S21 through S23 for different meta-path graphs to partition all meta-path graphs and obtain all meta-path subgraphs. A meta-path subgraph is a subgraph derived from the structure and vertex relationships of a specific meta-path graph. A meta-path subgraph is composed of vertices and edges that satisfy the conditions of a particular meta-path, reflecting the relationships between vertices in a specific context.

Step S3 comprises the following sub-steps.

At Step S31, a meta-path subgraph is divided by layer into several parts, each containing multiple consecutive layers. Each subgraph represents a portion of the meta-path instances, referred to as a meta-path slice graph herein.

Specifically, for a meta-path subgraph, the different layer structures are identified and divided. The meta-path subgraph is partitioned into several parts by layer, with each part containing multiple consecutive layers. Each part forms a new subgraph, i.e., a meta-path slice graph. Every meta-path slice graph will include part of the meta-path instances, with the key goal of preserving the relationship between consecutive layers and ensuring information continuity.

This layered approach effectively reduces computational complexity, making subsequent encoding and analysis more efficient. It also helps preserve inter-layer relationships, enhancing the HGNN model's ability to process multi-layer information in a heterogeneous graph.

At Step S32, the meta-path slice graphs are traversed in the order of their layers, so as to obtain all meta-path instance slices.

Specifically, for every meta-path slice graph, traversal is performed in layer order, either from bottom to top or top to bottom. During traversal, vertices and edges related to the meta-path are extracted to form complete meta-path instance slices. The structural features and connectivity of each meta-path instance slice are recorded.

This step ensures integrity and correctness of every meta-path instance slice, allowing subsequent analysis to be based on accurate structural information. The efficient implementation of the traversal algorithm can further accelerate data processing and save computational time.

Step S33 involving repeating Steps S31 and S32 for different meta-path slice graphs, so as to obtain slices for all meta-path instances.

Specifically, for each meta-path slice graphs, Steps S31 and S32 are repeated. After processing each meta-path slice graph, all the corresponding meta-path instance slices are stored to maintain data consistency and integrity throughout processing.

By systematically processing every meta-path slice graph, all relevant meta-path instance slices are obtained, providing a solid data foundation for subsequent aggregation and encoding. This systematic repetition not only improves data coverage, but also enhances the HGNN model's adaptability to various meta-paths, thereby improving its generalization ability.

Step S4 comprises the following sub-steps.

At Step S41, all meta-path instance slices for a given meta-path graph are encoded to obtain partial encodings for the meta-path instances.

Specifically, this step involves determining whether there are any identical sequential parts in the meta-path definitions corresponding to the meta-path graphs. If such parts exist, priority-based layer division is performed, giving preference to dividing these identical sequential parts into subgraphs. Otherwise, layer-based division is performed, where the meta-path graph is directly divided into subgraphs with two layers each.

At Step S42, after obtaining the encodings for the meta-path instance slices in the meta-path graph, the encodings for the meta-path instance slices in different subgraphs are re-encoded using the relationships among edges in different layers to obtain the final encodings for all meta-path instances.

Specifically, after the encodings for meta-path instance slices in each meta-path graph are obtained, the relationships between edges in different layers are identified. According to these edge relationships, the encodings for meta-path instance slices from different subgraphs are merged and re-encoded. An aggregation function (such as summing, averaging, or other complex aggregation methods) is used to integrate the encodings from different layers and generate a global encoded representation.

This re-encoding process further enhances the relationship information among vertices, and helps capture cross-layer features, making the HGNN model more capable of understanding complex relationships. By effectively merging the encodings from different subgraphs, a more comprehensive and richer feature representation can be obtained.

At Step S43, after all meta-path graphs have their meta-path instances encoded, internal aggregation is performed on the meta-path instances within the same meta-path subgraph to aggregate the meta-path instances of the same target vertices, so as to obtain the feature information of that target vertex.

Specifically, after encoding all the meta-path instances in the meta-path graphs, the meta-path instances with the same target vertex within each meta-path subgraph are aggregated. An aggregation method (e.g., max pooling, average pooling, etc.) is used to integrate the feature information for the same target vertex, resulting in a feature representation for each target vertex. This ensures information consistency and integrity during aggregation and prevents information loss.

This aggregation step effectively reduces noise and emphasizes the core features of the target vertex, thereby improving the accuracy of subsequent analysis. By internally aggregating the feature information of different meta-path instances, the richness and accuracy of the target vertex features are ensured.

At Step S44, for all meta-path instance slices from different meta-path graphs, Steps S41 through S43 are repeated to obtain the feature information of all target vertices under different meta-paths.

Step S45 involves aggregating the feature information for the same target vertices across different meta-path graphs to obtain the final features for all target vertices.

Specifically, the feature information for the same target vertex across different meta-path graphs is aggregated, and duplicate target vertices are identified. A suitable aggregation strategy (such as weighted average, voting, etc.) is used to merge the features of the same target vertex and generate the final feature representation, so as to ensure that the impact of different meta-paths on the target vertex features during aggregation is considered, maintaining the diversity and accuracy of the information.

Cross-graph aggregation integrates information from different meta-path graphs to provide a more comprehensive and accurate vertex feature representation. This process helps improve the performance of the final HGNN model in specific tasks (such as classification, regression, etc.), providing more robust support for subsequent decision-making.

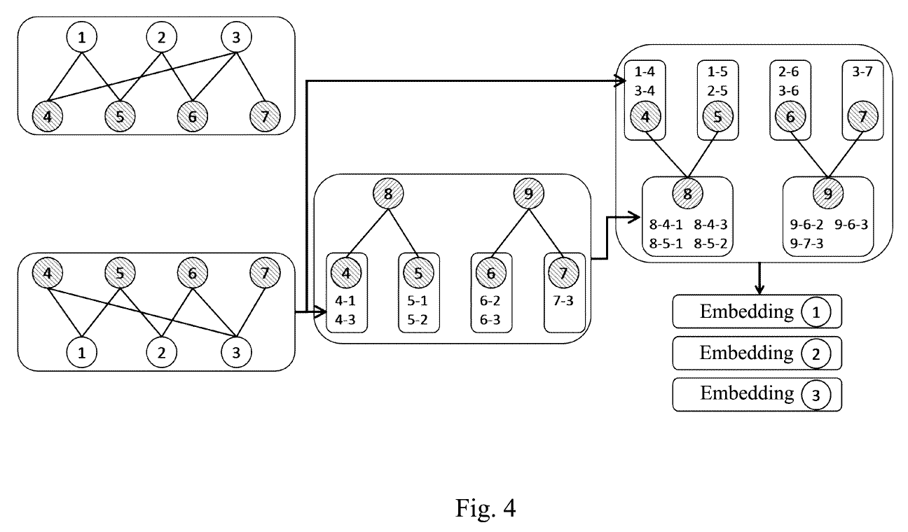

For ease of understanding and explanation, the present disclosure will be further described with reference to a specific application, as illustrated in FIG. 3 and FIG. 4.

Referring to FIG. 3, FIG. 3(a) shows a heterogeneous graph representing paper citations. It includes three types of vertices: Author (A), Paper (P), and Conference (C), which represent information about authors, papers, and conferences, respectively. The graph also includes two types of edges: A-P represents that an author wrote a paper, and P-C represents that a paper was published at a conference. A given meta-path, APA, represents the scenario where two authors co-authored a paper. The extraction module 106 extracts the vertices and edges in the heterogeneous graph that match the meta-path, as shown in FIG. 3(b). The expansion module 107 then constructs the extracted part (as shown in FIG. 3(b)) into a complete meta-path graph, as shown in FIG. 3(c).

In the existing art, semantic information is typically captured using a semantic graph and a list of meta-path instances. The present disclosure fundamentally changes the existing approach by using meta-path graphs to capture semantic information, eliminating the need to construct a semantic graph or store all meta-path instances. This not only avoids the high overheads of semantic graph construction but also significantly reduces the storage overhead of meta-path instances.

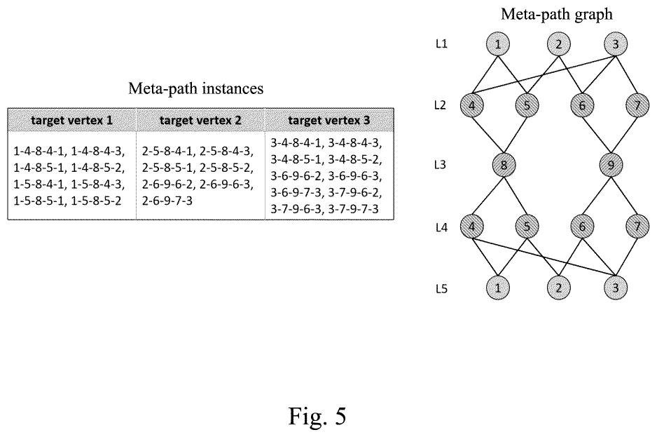

FIG. 5 shows a table and a meta-path graph, which include all meta-path instances corresponding to the meta-path APCPA in the heterogeneous graph of FIG. 3(a). The meta-path graph can be partitioned into five layers (L1 to L5). Storing these meta-path instances involves a huge number of repeated vertices. FIG. 4 shows how all meta-path instances are stored as meta-path graphs.

As shown in FIG. 4, the meta-path APCPA includes two parts: “AP” and “PA”. These two consecutive parts are identical, so the corresponding encodings only needs to be computed once. Statistical analysis shows that there are 25 APCPA meta-path instances in total in the heterogeneous graph. During this process, the redundant computation in HGNN primarily occurs during the encoding stage of the meta-path instances. In this stage, each meta-path instance (such as 1-4-8-4-1) must be encoded into a vector. This encoding operation is a simple linear operation, such as MEAN (averaging the feature vectors of every vertex in the meta-path instances). Thus, for different meta-path instances, such as 1-4-8-4-1 and 1-4-8-4-3, significant redundant computation occurs, as the common portion (1-4-8-4) of these meta-path instances is encoded multiple times. In those known methods, this requires 100 computations (25*4), whereas the layer-based encoding method needs only 39 computations. This significantly reduces redundant computation and storage overhead, while enhancing the inference efficiency of the HGNN model.

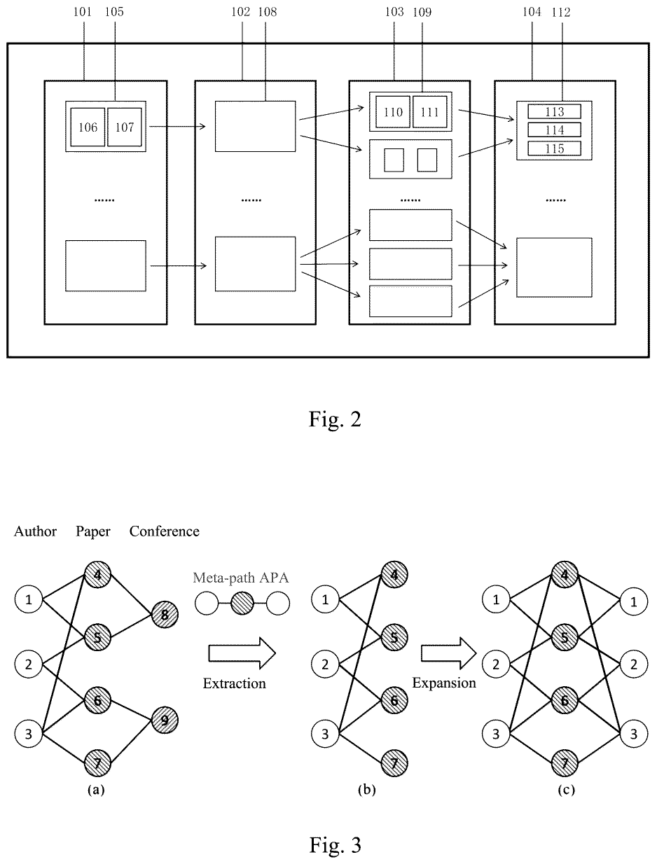

As shown in FIG. 2, the present disclosure provides a parallel implementation system for an HGNN acceleration method based on meta-path graphs. The system includes a construction module 101, a partitioning module 102, a computation module 103, and a merging module 104. The construction module 101 and the partitioning module 102 are in connection with each other. The partitioning module 102 is connected to the computation module 103. The computation module 103 is connected to the merging module 104.

Preferably, the construction module 101, the partitioning module 102, the computation module 103, and the merging module 104 can operate on a multi-core processor or a multi-thread server. Each module operates as a separate thread or process, utilizing multi-thread parallel processing to improve performance. For example, a multi-core processor (such as one with 8 cores or more) may be Intel Xeon E5-2699 v4 (22 cores/44 threads), or an AMD EPYC 7742 (64 cores/128 threads). A multi-thread server can be a Dell PowerEdge R740 server with two Intel Xeon Scalable processors, supporting up to 56 cores, or an HPE ProLiant DL380 Gen10 server with two AMD EPYC processors, supporting up to 128 cores.

The construction module 101 and the partitioning module 102 can use the server's high-speed bus (such as QPI (QuickPath Interconnect) or Infinity Fabric) for data transmission within the multi-core processor. The partitioning module 102 and the computation module 103 can be connected using high-speed memory access (such as NUMA architecture). The computation module 103 and the merging module 104 can use the server's high-speed bus (such as QPI or Infinity Fabric) for inter-module data transmission.

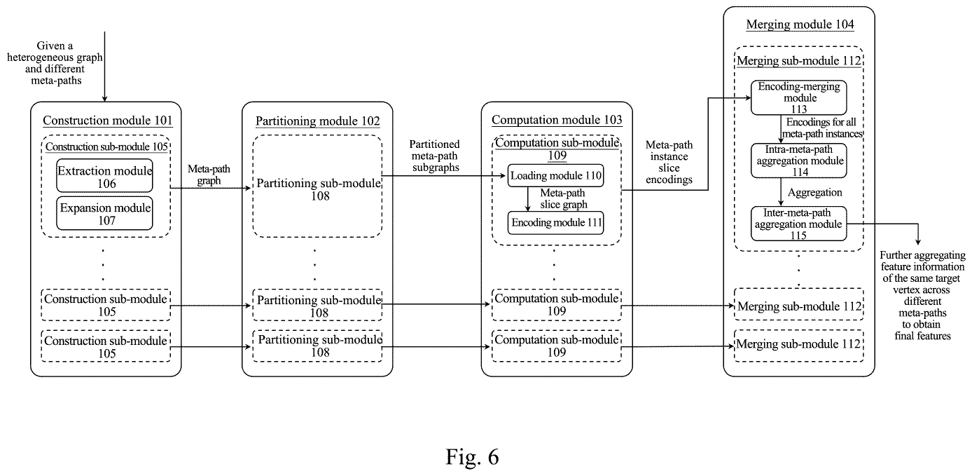

As shown in FIG. 2 and FIG. 6, the construction module 101 is responsible for constructing meta-path graphs from the given heterogeneous graph and various meta-paths. The construction module 101 is composed of multiple construction sub-modules 105. Each construction sub-module 105 includes an extraction module 106 and an expansion module 107. The extraction module 106 extracts the vertices and edges matching the meta-path from the heterogeneous graph. The expansion module 107 is responsible for constructing the extracted parts into a complete meta-path graph. Once constructed, the meta-path graph is sent to the partitioning module 102.

When the construction module 101 is an independent processor, it may be a high-performance multi-core CPU, such as the Intel Xeon E5-2699 v4 (22 cores/44 threads).

When the construction module 101 consists of multiple hardware components, the construction sub-module 105 may include a data processing unit, memory, and input/output ports. The construction sub-module 105 may include a processor or FPGA (Field-Programmable Gate Array) to perform the computation tasks for the extraction module 106 and the expansion module 107. These hardware components can efficiently process graph data and perform complex computations. To store the heterogeneous graph, the extracted vertices and edges, and the constructed meta-path graph, the construction sub-module 105 may further include memory components, such as SRAM or DRAM. The construction sub-module 105 may also have connection ports (e.g., USB, Ethernet, etc.) for receiving the input heterogeneous graph and sending the constructed meta-path graph to the partitioning module 102. For efficient large-scale data processing, the construction sub-module 105 may have parallel processing capabilities, using multiple cores or processing units to process multiple data streams simultaneously.

Where the extraction module 106 and the expansion module 107 are hardware components forming part of the construction sub-module 105, the extraction module 106 may include a data-collection unit, processor or accelerator, memory, and ports. The data-collection unit (e.g., a data-receiving port) receives data from the heterogeneous graph to ensure access to vertex and edge information. The processor or accelerator (e.g., CPU or GPU) runs graph algorithms and analyzes the heterogeneous graph to identify and extract vertices and edges that match specific meta-paths. The memory (e.g., DDR4 RAM) provides sufficient storage space to cache extracted vertices and edges for subsequent processing. The ports transmit the extracted data to the expansion module 107.

The expansion module 107 includes a computing unit, memory and ports. The computing unit (e.g., CPU (AMD EPYC or Intel Xeon processor) or GPU (NVIDIA A100)) processes the extracted vertices and edges and executes the necessary logic and algorithms to construct the complete meta-path graph. The memory (e.g., DDR4 or DDR5 RAM) has sufficient capacity to store intermediate results generated during construction and final meta-path graphs for fast access and modification. The ports may be network-interface cards (NICs), such as Ethernet cards from Broadcom or Intel, for sending the meta-path graph data to the partitioning module 102. Alternatively, output modules itself can be storage interfaces, such as SATA or NVMe interfaces, for storing the generated graphs to disks or SSDs for subsequent processing. As shown in FIG. 2 and FIG. 6, the partitioning module 102 consists of multiple partitioning sub-modules 108. The partitioning sub-modules 108 partition the meta-path graphs into multiple subgraphs. The resulting meta-path subgraphs are then sent to the computation module 103.

When the partitioning module 102 is an independent processor, it can be a high-performance multi-core CPU, such as the AMD EPYC 7742 (64 cores/128 threads).

Preferably, when the partitioning module 102 is composed of multiple hardware components, the partitioning sub-module 108 may include a processor, memory, storage devices, and ports. The processor may be a high-performance multi-core CPU, such as the AMD EPYC 7742 that has 64 cores and 128 threads, and handles parallel partitioning tasks, thereby significantly improving computation efficiency. High-bandwidth memory (e.g., DDR4 or DDR5) stores the meta-path graphs and intermediate results during partitioning, so as to ensure sufficient storage capacity and fast access for processing large-scale graph data. Additionally, fast data read/write operations can be facilitated using NVMe SSDs, such as Samsung 970 EVO or Western Digital Black SN750. This allows fast storage and retrieval of the partitioned graph data. In order to further accelerate graph-partitioning computation, the partitioning sub-module 108 may further be equipped with GPUs (such as NVIDIA A100/Tesla V100) or FPGAs (such as Xilinx Virtex series) for accelerated parallel computation, especially when processing complex graphs. Meanwhile, for ensuring efficient data transmission, also essential are high-performance Ethernet cards (such as Mellanox ConnectX series). This ensures fast data transfer of the generated subgraphs to the computation module 103 for further processing. With the combination of these hardware components, the partitioning sub-module 108 can work efficiently to support subsequent computation with a solid basis.

As shown in FIG. 2 and FIG. 6, the computation module 103 is composed of multiple computation sub-modules 109. The computation sub-modules 109 are responsible for encoding the meta-path subgraphs. Each computation sub-module 109 includes a loading module 110 and an encoding module 111. The loading module 110 distributes the workloads of the meta-path subgraphs in a layer-based manner, generating meta-path slice graphs. The encoding module 111 traverses and encodes the meta-path slice graphs.

When the computation module 103 is an independent processor, it may be a high-performance multi-core CPU, such as the AMD EPYC 7742 (64 cores/128 threads).

When the computation sub-modules 109 are processors, multi-core CPUs (e.g., Intel Xeon or AMD Ryzen series) may be used to support parallel computation for complex encoding tasks. Meanwhile, GPUs (e.g., NVIDIA RTX or AMD Radeon series) can accelerate parallel computation for large-scale data, especially when traversing and encoding meta-path slice graphs. In addition, large-capacity DDR4 or DDR5 memory is essential for high-speed data access and prevents bottlenecks during processing. As to storage, high-speed NVMe SSDs (e.g., Samsung 970 EVO or Western Digital Black SN850) help with fast data access to meta-path subgraphs and slice graphs.

As components of the computation sub-module 109, the loading module 110 and the encoding module 111 are each composed of specific physical hardware. The loading module 110 is primarily responsible for distributing loads in the layer-based manner, and its hardware may include a multi-core processor, such as the AMD Ryzen 9 5950X or Intel Core i9-11900K, along with high-frequency DDR4 or DDR5 memory modules, such as Corsair Vengeance LPX series. Additionally, load balancers like F5 BIG-IP and Mellanox ConnectX-6 network interface cards may be used to ensure efficient resource management and fast data transmission. The encoding module 111 focuses on traversing and encoding the meta-path slice graphs, typically equipped with powerful graph processing units (GPUs), such as the NVIDIA A100 or RTX 3080, and Intel Xeon Gold processors to enhance encoding efficiency. It also requires high-speed SSD storage device, such as the Samsung 970 NVMe SSD, for fast access to encoded data, as well as high-capacity DDR4 or DDR5 memory to ensure stable processing. With these optimized hardware combinations, the loading module 110 and the encoding module 111 can efficiently collaborate, boosting the overall performance of the computation sub-module. As shown in FIG. 2 and FIG. 6, the merging module 104 is composed of multiple merging sub-modules 112. The merging sub-modules 112 merge the encodings for meta-path instance slices and perform subsequent aggregation computations. Each merging sub-module 112 includes an encoding-merging module 113, an intra-meta-path aggregation module 114, and an inter-meta-path aggregation module 115. The encoding-merging module 113 is responsible for merging the encodings for meta-path instance slices to obtain the encodings for all meta-path instances. The intra-meta-path aggregation module 114 aggregates the encodings for meta-path instances with the same target vertex under the same meta-path to generate feature information of the target vertex. The inter-meta-path aggregation module 115 further aggregates feature information of the same target vertex across different meta-paths to obtain final features.

When the merging module 104 is implemented as an independent processor, it may consist of a high-performance multi-core CPU or GPU, such as the NVIDIA Tesla V100 or A100, for accelerating computations.

If the construction module 101 and the partitioning module 102 are located on different physical servers, network connection may be established using high-speed Ethernet (such as 10 GbE or 40 GbE). The partitioning module 102 and the computation module 103 use a PCIe (PCI Express) bus to connect the CPU and GPU, thereby supporting high-speed data transmission. The computation module 103 and the merging module 104 use a PCIe bus to facilitate data transmission between the CPU and GPU.

With this configuration, the disclosed system efficiently realizes meta-path graph construction and encoding computations, while significantly enhancing HGNN inference efficiency. The independence of the modules and their parallel processing capabilities enable the system to handle large-scale heterogeneous graph data and satisfy practical application needs.

As part of the merging module 104, the merging sub-module 112 may be composed of several physical hardware components to perform the merging of meta-path instance slice encoding and subsequent aggregation computations. The merging sub-module 112 may be equipped with a multi-core processor, such as the AMD Ryzen 9 5900X or Intel Xeon Platinum series, which provides powerful multi-threaded processing capability suitable for complex merging and aggregation tasks. The merging sub-module 112 also includes a high-performance graph processing unit (GPU), such as the NVIDIA RTX 3080 or AMD Radeon RX 6900 XT, to accelerate encoding-merging and aggregation operations. Particularly, for processing large-scale data, it significantly improves computational efficiency. The merging sub-module 112 also features high-capacity memory, such as Corsair Vengeance LPX 32 GB DDR4 memory, to ensure ample space for storing temporary data and computation results during large-scale aggregation. For fast data access, the merging sub-module 112 may further be equipped with a high-speed SSD, such as the Samsung 970 EVO Plus NVMe SSD, to provide excellent data read/write performance. The merging sub-module 112 is equipped with a Mellanox ConnectX-6 network interface card for high-speed inter-module data transfer, ensuring efficient data processing.

As hardware components of the merging sub-module 112, the intra-meta-path aggregation module 114 and the inter-meta-path aggregation module 115 are each responsible for specific aggregation tasks. Therefore, their hardware designs are tailored to meet the needs of their respective functions. The intra-meta-path aggregation module 114 may comprise a multi-core processor, such as the AMD Ryzen 7 5800X or Intel Core i7 series, which offers strong multi-thread processing capabilities. This is ideal for handling aggregation tasks involving massive encodings for meta-path instances related to the same target vertex. Additionally, a 32 GB or larger DDR4 memory (such as Corsair Vengeance LPX) can process and store a huge amount of data during aggregation, thereby accelerating computations. The module may also include a high-speed SSD, such as the Samsung 970 EVO NVMe SSD, to ensure fast data access and storage during the aggregation process. By contrast, the hardware components of the inter-meta-path aggregation module 115 may include a high-performance GPU, such as the NVIDIA A100 or RTX 3090, to accelerate aggregation computations for feature information of the same target vertex under different meta-paths. These GPUs provide powerful processing capabilities, making them well-suited for complex data processing tasks. In addition, multi-core processors from Intel Xeon Silver or AMD EPYC may be used in the inter-meta-path aggregation module 115 to support large-scale data processing and complex aggregation tasks. A 64 GB or larger DDR4 memory ensures sufficient memory space for efficient feature information aggregation across meta-paths. With these hardware combinations, the intra-meta-path aggregation module 114 and the inter-meta-path aggregation module 115 can efficiently conduct their respective aggregation tasks, thereby enhancing the overall computing performance and efficiency of the merging module 104.

Furthermore, in the disclosed system, each module's port is assigned a unique ID, ensuring smooth transmission and processing of data from the heterogeneous graph through to the final feature information.

The extraction module 106 comprises a 1^{st} port for receiving heterogeneous graph data and a 2^{nd} port for sending the extracted data. The expansion module 107 comprises a 3^{rd} port for receiving the extracted data and a 4^{th} port for sending the constructed meta-path graph. The 2^{nd} port and the 3^{rd} port are connected, with this connection being wired, for example, via a Cat 6 Ethernet cable.

The expansion module 107 then sends the constructed meta-path graph from the 4^{th} port to a 5^{th} port of the partitioning module 102, thereby accomplishing a seamless connection from extraction to expansion. The 4^{th} port and the 5^{th} port can be wired together using, for example, a Cat 6 Ethernet cable.

The partitioning sub-module 108 receives the meta-path graph from the construction module 101 through the 5^{th} port, and sends the partitioned meta-path subgraphs to a 7^{th} port of the loading module 110 via a 6^{th} port. The 6^{th} port is connected to the 7^{th} port of the loading module 110. This connection is wired, for example, using a Cat 6 Ethernet cable to transmit data sequentially.

The loading module 110 receives the meta-path subgraphs through the 7^{th} port, and sends the generated meta-path slice graphs to a 9^{th} port of the encoding module 111 via an 8^{th} port. The 8^{th} port and the 9^{th} port are connected for structured data exchange.

The encoding module 111 receives the meta-path slice graphs through the 9^{th} port, and sends the encoded meta-path instance slice graph to an 11^{th} port of the merging module 104 through a 10^{th} port. The connection supports Unicode data exchange. The 10^{th} port and the 11^{th} port can be wired together using, for example, an optical fiber for structured data exchange, ensuring fast and stable data transmission.

The encoding-merging module 113 receives data through the 11^{th} port, and sends the merged meta-path instance encodings to a 13^{th} port of the intra-meta-path aggregation module 114 via a 12^{th} port. This connection facilitates data integration. The 12^{th} port and the 13^{th} port may be wired using, for example, an optical fiber for data integration.

The intra-meta-path aggregation module 114 receives the merged meta-path instance encodings through the 13^{th} port, and sends the aggregated feature information of the target vertices to a 15^{th} port of the inter-meta-path aggregation module 115 through a 14^{th} port. This connection is for feature aggregation. The 14^{th} port and the 15^{th} port t may be wired using, for example, an optical fiber to transmit information in the manner of feature aggregation.

At last, the inter-meta-path aggregation module 115 receives the post-aggregation feature information of the target vertices through the 15^{th} port, and outputs the final feature information through a 16^{th} port, thereby closing the loop of data processing.

It should be noted that the above specific embodiments are exemplary. Skilled artisans, inspired by the present disclosure, can devise various solutions that fall within the scope of the present application and are protected by it. Furthermore, those skilled in the art will recognize that the description and accompanying drawings provided herein are illustrative and form no limitation to any of the appended claims. The scope of the present application is defined by the appended claims and equivalents thereof. The present application provided herein encompasses multiple inventive concepts, indicated by phrases such as “preferably” and “according to a preferred embodiment”, each denoting a distinct concept disclosed in the respective paragraph. The applicant reserves the right to file one or more divisional applications based on each inventive concept.

What is claimed is:

1. An acceleration method for heterogeneous graph neural networks based on meta-path graphs, the method comprising:
constructing a meta-path graph by arranging all meta-path instances in graph form, based on a given heterogeneous graph and specified types of meta-paths;
partitioning the meta-path graph to obtain multiple meta-path subgraphs;
dividing the meta-path subgraphs by workload;
performing layer-based encoding on the meta-path instances according to the workload distribution, and merging all meta-path instance slice encodings based on inter-layer relationships in the meta-path graph, so as to obtain meta-path instance encodings; and
performing intra-meta-path aggregation and inter-meta-path aggregation to compute final features of target vertices.

2. The acceleration method of claim 1, wherein the step of constructing the meta-path graph comprises:
extracting vertices and edges from the heterogeneous graph according to the types appearing in the meta-paths; and
copying repeated vertices and edges into the previously constructed portion of the meta-path graph, and expanding further according to the meta-path schema, so as to form a complete meta-path graph.

3. The acceleration method of claim 1, wherein the step of partitioning the meta-path graph comprises:
collecting the vertices in central layers of the meta-path graph, so as to obtain all central-layer vertices of the meta-path graph;
dividing the central-layer vertices into multiple batches, each batch containing an equal number of the central-layer vertices; and
traversing the meta-path graph from all the vertices in each batch, respectively, in both outgoing and incoming edge directions, so as to obtain the meta-path subgraphs corresponding to each batch.

4. The acceleration method of claim 1, wherein the step of dividing the meta-path subgraphs by workload comprises:
dividing the meta-path subgraph into at least two sections by layer, with each section containing contiguous layers, thus forming a meta-path slice graph that contains part of the meta-path instances; and
traversing the meta-path slice graphs in sequence of layers, so as to obtain slices for all the meta-path instances.

5. The acceleration method of claim 1, wherein the meta-path instance encodings are obtained through:
encoding the meta-path instance slices to obtain partial encodings for the meta-path instances;
using edge relationships among different layers to re-encode the meta-path instance slice encodings in different subgraphs, so as to obtain all the meta-path instance encodings;
performing intra-meta-path aggregation for the same meta-path subgraph, so as to obtain feature information of the target vertices; and
performing inter-meta-path aggregation for the feature information of the target vertices shared across different meta-path graphs, so as to compute the final features of all the target vertices.

6. The acceleration method of claim 5, wherein the step of encoding the meta-path instance slices comprises:
determining whether there is any sequential part that is identical among meta-path definitions corresponding to the meta-path graphs; and
if yes, implementing priority-based layer division; otherwise, implementing layer-based division.

7. The acceleration method of claim 2, wherein the step of constructing the meta-path graph further includes:
analyzing the type of each vertex and edge in the meta-path and recording the definition of each type in the heterogeneous graph.

8. The acceleration method of claim 7, wherein the step of constructing the meta-path graph further includes:
using database queries or graph traversal algorithms to extract vertices and edges corresponding to each type in the meta-path from the heterogeneous graph, ensuring that the extracted edges connect vertices in accordance with the order and type requirements of the meta-path.

9. The acceleration method of claim 4, wherein the method further includes:
during the traversal, extracting the vertices and edges related to the meta-path to form complete meta-path instance slices, and recording the structural features and connectivity of each meta-path instance slice.

10. The acceleration method of claim 5, wherein the method further includes:
after encoding for all meta-path instances of the meta-path graphs, for every meta-path subgraph, aggregating the meta-path instances of the same target vertex, wherein an aggregation method is used to integrate the feature information of the same target vertex and generate the feature representation for each target vertex, so as to ensure consistency and integrity of the information throughout the aggregation process.

11. An acceleration system for heterogeneous graph neural networks based on meta-path graphs, the system comprising:
a construction module, for constructing a meta-path graph by arranging all meta-path instances in graph form, based on a given heterogeneous graph and specified types of meta-paths;
a partitioning module, for partitioning the meta-path graph to obtain multiple meta-path subgraphs;
a computation module, for dividing the meta-path subgraphs by workload; and
a merging module, for performing layer-based encoding on the meta-path instances according to the workload distribution, and merging all meta-path instance slice encodings based on inter-layer relationships in the meta-path graph, so as to obtain meta-path instance encodings; and for performing intra-meta-path aggregation and inter-meta-path aggregation to compute final features of target vertices.

12. The acceleration system of claim 11, wherein the construction module comprises multiple construction sub-modules for constructing the meta-path graphs, wherein
the construction sub-modules each comprise an extraction module and an expansion module, wherein
the extraction module extracts vertices and edges from the heterogeneous graph according to the types appearing in the meta-paths; and
the expansion module copies repeated vertices and edges into the previously constructed portion of the meta-path graph, and expands further according to the meta-path schema, so as to form a complete meta-path graph.

13. The acceleration system of claim 12, wherein the partitioning module comprises multiple partitioning sub-modules, which are used to partition the meta-path graphs into multiple subgraphs, and after the partitioning is completed, the resulting meta-path subgraphs are sent to the computation module.

14. The acceleration system of claim 13, wherein the computation module comprises multiple computation sub-modules, wherein
the computation sub-modules divide the meta-path subgraphs by workload according to layers, so as to obtain multiple meta-path slice graphs and perform encoding computations; and
the computation sub-modules each include a loading module and an encoding module, wherein
the loading module divides the meta-path subgraph into at least two sections by layer, with each section containing contiguous layers, thus forming a meta-path slice graph that contains part of the meta-path instances; and
the encoding module traverses the meta-path slice graphs in sequence of layers, so as to obtain slices for all the meta-path instances.

15. The acceleration system of claim 14, wherein the merging module comprises multiple merging sub-modules, wherein
the merging sub-modules each include an encoding-merging module, an intra-meta-path aggregation module, and an inter-meta-path aggregation module, wherein
the code-merging module encodes the meta-path instance slices to obtain partial encodings for the meta-path instances, and uses edge relationships among different layers to re-encode the meta-path instance slice encodings in different subgraphs, so as to obtain all the meta-path instance encodings;
the intra-meta-path aggregation module performs intra-meta-path aggregation for the same meta-path subgraph, so as to obtain feature information of the target vertices; and
the inter-meta-path aggregation module performs inter-meta-path aggregation for the feature information of the target vertices shared across different meta-path graphs, so as to compute the final features of all the target vertices.

16. The acceleration system of claim 15, wherein the extraction module includes a first port for receiving heterogeneous graph data and a second port for sending extracted data; and
the expansion module includes a third port for receiving extracted data and a fourth port for sending the completed meta-path graph,
wherein the second port and the third port are in connection with each other.

17. The acceleration system of claim 16, wherein the expansion module sends the completed meta-path graph through the fourth port to a fifth port of the partitioning module, achieving a seamless connection from extraction to expansion.

18. The acceleration system of claim 17, wherein the partitioning submodules receive the meta-path graph from the construction module via the fifth port and send the partitioned meta-path subgraphs to the load module via a sixth port, with the sixth port connected to a seventh port of the load module.

19. The acceleration system of claim 18, wherein the load module receives the meta-path subgraph through the seventh port and sends the generated meta-path slice graph to the encoding module via an eighth port, with the eighth port in structured data exchange connection with a ninth port of the encoding module.

20. The acceleration system of claim 19, wherein the encoding module receives the meta-path slice graph through the ninth port and sends the encoded meta-path instance slice graph to the merging module through a tenth port, with the tenth port in Unicode-supported connection with an eleventh port of the merging module.
